(19) United States
(12) Patent Application Publication
(10) Pub. No.: US 2014/0174400 A1
(43) Pub. Date: Jun. 26, 2014

(54) SPLIT-ANGLE CONNECTING ROD

(71) Applicant: CATERPILLAR INC., Peoria, IL (US)

(72) Inventors: James Dean Dunbar, East Peoria, IL (US); Michael Ray Hess, Lafayette, IN (US); Lucas John Moehling, Metamora, IL (US)

(73) Assignee: CATERPILLAR INC., Peoria, IL (US)

(21) Appl. No.: 13/722,835

(22) Filed: Dec. 20, 2012

(51) Int. Cl. F16C 7/02

(52) U.S. Cl. CPC F16C 7/023
USPC 123/197.3

(57) ABSTRACT

The disclosure is directed to a connecting rod, The connecting rod may include a first end having a bore configured to receive a piston pin, and a second end having a yoke and a cap removably connected to the yoke at a separation plane. Together, the yoke and the cap may define a bore configured to receive a crankshaft. The connecting rod may also include a shank extending between the first and second ends and being generally symmetrical about a longitudinal plane that may be oriented at an oblique angle with respect to the separation plane. The connecting rod may further include a radial thickness of a shoulder that is greater than a radial thickness of the yoke at the separation plane.

### TECHNICAL FIELD

The present disclosure relates generally to a connecting rod, and more particularly, to a connecting rod having an oblique split-angle.

### BACKGROUND

Internal combustion engines convert chemical energy in fuel into mechanical energy through a series of explosions within a combustion chamber of the engine. These explosions cause pistons of the engine to reciprocate within enclosed spaces called cylinders. Each piston is typically connected to a crankshaft by a connecting rod, such that movement of the piston results in rotation of the crankshaft. Traditionally, a removable cap and a plurality of bolts are used for securing the connecting rod to the crankshaft. Together, the connecting rod and the removable cap define a crank end bore, which houses a two-piece bearing.

There are generally two types of connecting rods. The first type of connecting rod has a 90° orientation between an axis of the connecting rod and a plane of separation at the cap. The second type has an oblique angle of orientation between the axis of the connecting rod and the plane of separation at the cap (e.g. about 45°). This second type of connecting rod is generally referred to as a split-angle connecting rod.

Split-angle connecting rods are generally used to improve assembly of the connecting rod by placing the bolts that connect the cap at a more accessible angle. However, during engine operation, split-angle connecting rods can experience tremendous stress under the load of the corresponding piston, as force from the explosion is mechanically transferred disproportionally through opposing ends of the connecting rod to the crankshaft. The stress tends to concentrate in specific areas of split-angle connecting rods, causing reduced component life and premature failure of the connecting rods. Specifically, the high stress areas can result in bore distortion, which may negatively affect bearing performance.

One attempt to improve bearing performance in split-angle connecting rods is described in U.S. Patent Application Publication No. 2007/0131191 (“the '191 publication”) to Hurban et al. that published on Jun. 14, 2007. In particular, the '191 publication describes a connecting rod including a rod and a cap, which together define a crankshaft bore. The cap includes a first split line and a second split line that are substantially parallel and non-coplanar relative to each other. The non-coplanar nature of the split lines is intended to reduce mechanical loading at the split lines.

Although the offset split lines of the '191 publication may help to reduce stress at the interface between the rod and the cap, there may be other areas of the connecting rod that still experience higher stress levels. Specifically, on split-angle connecting rods, higher stress areas may be located between the split line and a shank of the connecting rod. The offset split lines of the '191 publication may be inefficient at reducing stress in those particular areas and, thus, may not adequately reduce bore distortion.

The connecting rod of the present disclosure solves one or more of the problems set forth above and/or other problems with existing technologies.

### SUMMARY

In one aspect, the disclosure is directed to a connecting rod. The connecting rod may include a first end having a bore configured to receive a piston pin, and a second end having a yoke and a cap removably connected to the yoke at a separation plane. Together, the yoke and the cap may define a bore configured to receive a crankshaft. The connecting rod may also include a shank extending between the first and second ends and being generally symmetrical about a. longitudinal plane that may he oriented at an oblique angle with respect to the separation plane. The connecting rod may further include a radial thickness of a shoulder that is greater than a radial thickness of the yoke at the separation plane.

In a second aspect, the disclosure is directed to another connecting rod. This connecting rod may include a first end having a bore configured to receive a piston pin, and a second end having a yoke and a cap removably connected to the yoke at a separation plane. Together, the yoke and the cap may define a bore configured to receive a crankshaft. The connecting rod may also include a shank extending between the first and second ends and being generally symmetrical about a longitudinal plane that is oriented at an oblique angle with respect to the separation plane. The connecting rod may further include a concave side having a first transitional radius of curvature where the shank transitions into the second end, and a convex side having a second transitional radius of curvature where the shank transitions into the second end. A ratio of the first transitional radius of curvature to the second transitional radius of curvature may be about 5:4.

### BRIEF DESCRIPTION OF THE DRAWINGS

FIG. 1 is a cross-sectional illustration of an exemplary disclosed internal combustion engine;

FIG. 2 is a cross-sectional illustration of an exemplary disclosed connecting rod that may be used in conjunction with the engine of FIG. 1; and

FIG. 3 is a cross-sectional view illustration taken along line A-A of the connecting rod of FIG. 2.

### DETAILED DESCRIPTION

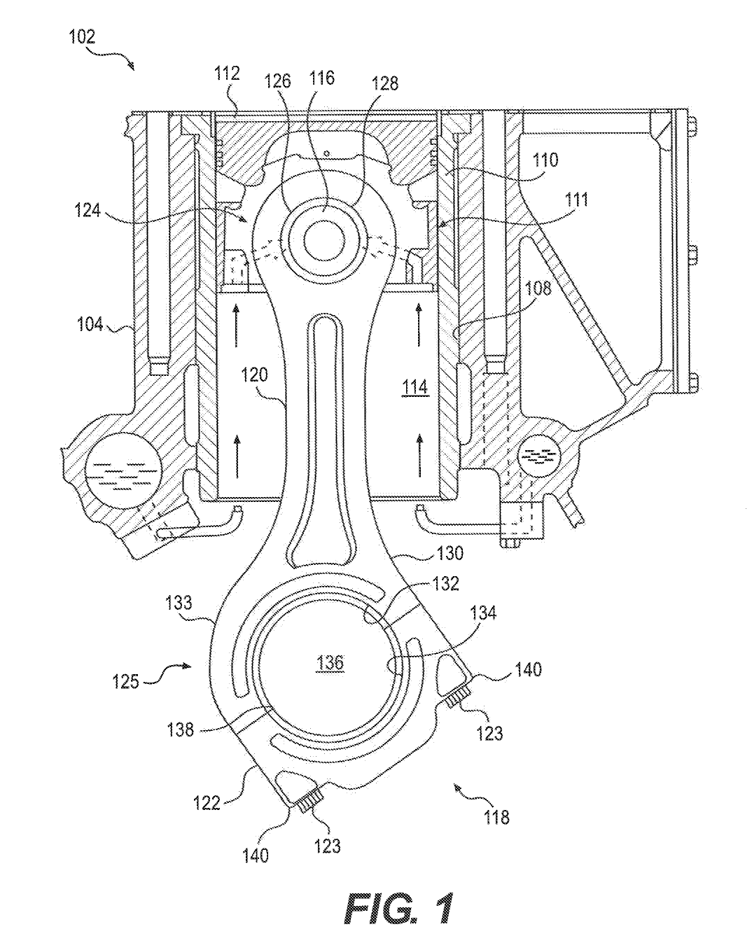

FIG. 1 illustrates an engine 102. Engine 102 is depicted in FIG. 1 and described herein as a diesel-fueled, internal combustion engine. However, it is contemplated that engine 102 may embody any other type of internal combustion engine such as, for example, a gasoline or gaseous fuel powered engine. It is contemplated that engine 102 may include any number of combustion chambers and that the combustion chambers may be disposed in an “in-line” configuration, in a “V” configuration, or in any other conventional configuration.

Engine 102 may include an engine block 104 at least partially defining a cylinder 108, and a cylinder liner 110 disposed in cylinder 108. A piston 111 may be located to reciprocate within cylinder liner 110. Piston 111, together with cylinder liner 110 and a cylinder head (not shown), may form a combustion chamber 112. Engine block 104 may also include a combustion air inlet, an air scavenging channel, and an exhaust outlet (not shown) in communication with combustion chamber 112. Additionally, a piston pin 116 may connect piston 111 to a connecting rod 118.

Connecting rod 118 may include a piston end 124, an opposing crank end 125, and a shank 120 extending between either end. Piston end 124 may include a bore 126 that houses a bearing 128. Bearing 128 may have an internal diameter that is sized to receive piston pin 116. Crank end 125 may include a yoke 130 and a cap 122. Yoke 130 may include a semi-circular opening 132 and a shoulder 133. Cap 122 may also include a semi-circular opening 134 that, together with semi-circular opening 132, define a crank end bore 136 for receiving a crankshaft (not shown) of engine 102. A bearing 138 may be disposed within semi-circular openings 132, 134 between the crankshaft and yoke 130 and cap 122. It is contemplated that bearing 138 may be a two-piece bearing for assembly purposes. Bearing 138 may be a friction-type bearing, fabricated from a malleable material, for example aluminum. It should be noted, however, that any other suitable material may alternatively be utilized for bearing 138. In addition, cap 122 may include a pair of shoulders 140 configured to receive a plurality of bolts 123, which allow cap 122 to be removably connected to crank end 125 of connecting rod 118.

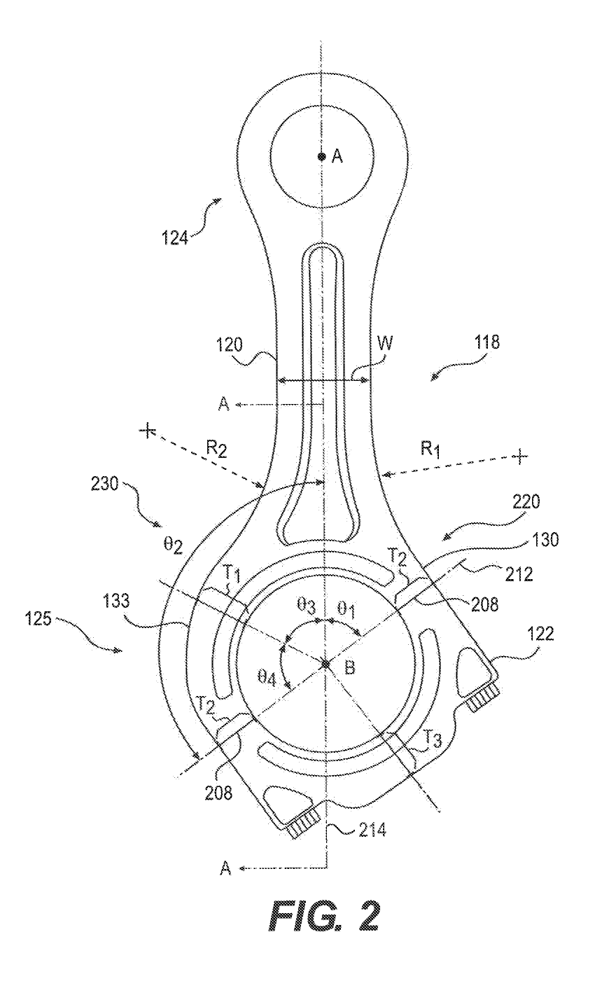

As shown in FIG. 2, cap 122 may be connected to yoke 130 at parting lines 208, in the disclosed embodiment, cap 122 and yoke 130 may have fractured, uneven surfaces that engage each other at parting lines 208, though other suitable forms of complimentary surfaces may alternatively be utilized. For example, in alternative embodiments, serrated or substantially flat machined surfaces may join cap 122 and yoke 130 at parting lines 208. For the purposes of this disclosure, the surfaces of cap 122 and yoke 130 at parting lines 208 may define a separation plane 212.

Shank 120 may be generally symmetric about a longitudinal plane 214 extending between a center axis A at piston end 124 and a center axis B at crank end 125. In one embodiment, shank 12( ) may have a width W of about 50 mm. As shank 120 transitions into yoke 130 at crank end 125, connecting rod 118 may have an asymmetric outer profile. Specifically, connecting rod 118 may have a concave side 220 at one side of shank 120 and a convex side 230 at an opposing side of shank 120. Concave side 220 and convex side 230 may be substantially asymmetrical.

At concave side 220, longitudinal plane 214 may be oriented at an oblique angle θ₁ with respect to separation plane 212. θ₁ may range between about 40° and 60°. In one embodiment, θ₁ may be about 55°. At convex side 230, longitudinal plane 214 may be oriented at an obtuse angle θ₂ with respect to separation plane 212. θ₂ may range between about 120° and 140°. In one embodiment, θ₂ may be about 125°. It should he noted that θ₁ and θ₂ may be supplementary angles adding up to 180°. The magnitudes of θ₁ and θ₂ may be dependent on design and assembly considerations, such as a diameter of cylinder liner 110, a diameter of crank end bore 136, an access positioning of bolts 123, and/or strength properties of connecting rod 118.

Concave side 220 and convex side 230 may also have substantially different transitional curvatures connecting shank 120 to crank end 125. Concave side 220 may have a transitional radius of curvature R₁, while convex side 230 may have a different transitional radius of curvature R₂. In one embodiment, R₁ may be about 150 mm and R₂ may be about 120 mm. In this embodiment, a ratio of R₁ to R₂ may be about 5:4.

In addition to the unique transitional profile described above, crank end 125 may have robustness, which may provide additional strength to connecting rod 118. More specifically, crank end 125 may have increased radial thickness in areas that tend to experience higher stress levels. Thus, radial thicknesses at various locations about center axis B may be substantially different. For example, an area along convex side 230 may have a greater radial thickness than other areas, relative to center axis B. It should be noted, however, that this location may be different, depending on where stress is heavily concentrated along crank end 125.

In the disclosed embodiment, crank end bore 136 may have an inner diameter of about 100 mm. Accordingly, all inner radii measured from center axis B to a surface of crank end bore 136 may be about 50 mm. In this embodiment, outer radii taken from center axis B to an outer surface of cap 122 and/or yoke 130 may vary substantially. This variation may cause different locations of cap 122 and yoke 130 to have different radial thicknesses about center axis B.

At one location about center axis B, shoulder 133 may have a radial thickness T₁. This location may be at an angle θ₃ with respect to longitudinal plane 214 and an angle θ₄ with respect to separation plane 212. In one embodiment, the outer radius at this location may be about 80 mm, when θ₃ is about 55° and θ₄ is about 70°. Thus, T₁ may be about 30 mm at this location.

Radial thicknesses at other locations may be substantially different than T₁. Specifically, T₁ may be greater than other radial thicknesses of cap 122 and yoke 130. For example, at parting lines 208, cap 122 and yoke 130 may each have a radial thickness T₂. At these locations, the outer radii may be about 75 mm and, therefore, T₂ may be about 25 mm. In this embodiment, a ratio of T₁ to T₂ may be about 6:5.

At a different location relative to center axis B, cap 122 may have a radial thickness T₃. This location may be about 90° clockwise with respect to separation plane 212 on concave side 220 and about 90° counterclockwise with respect to separation plane 212 on convex side 230. In one embodiment, T₃ may be located about 35° from longitudinal axis 214. At this location, the outer radius may be about 78 mm, and therefore, T₃ may be about 28 mm. In this embodiment, a ratio of T₁ to T₃ may be about 15:14.

The increased thickness at shoulder 133 of yoke 130 may provide additional strength in that specific area of connecting rod 118. It is contemplated that, because of the oblique angle nature of connecting rod 118, there may be disproportionate stress concentrations along concave side 220 and convex side 230. In particular, as piston 111 moves connecting rod 118 about the crankshaft, stress may concentrate heavily along convex side 230 because of the obtuse angular relationship between separation plane 212 and longitudinal axis 214 on that side of connecting rod 118. The increased thickness at shoulder 133 may compensate for the elevated stress by adding material to support the high stress levels. This may reduce distortion of crank end bore 136 and, thus, allow sufficient bearing lubrication and extend bearing life.

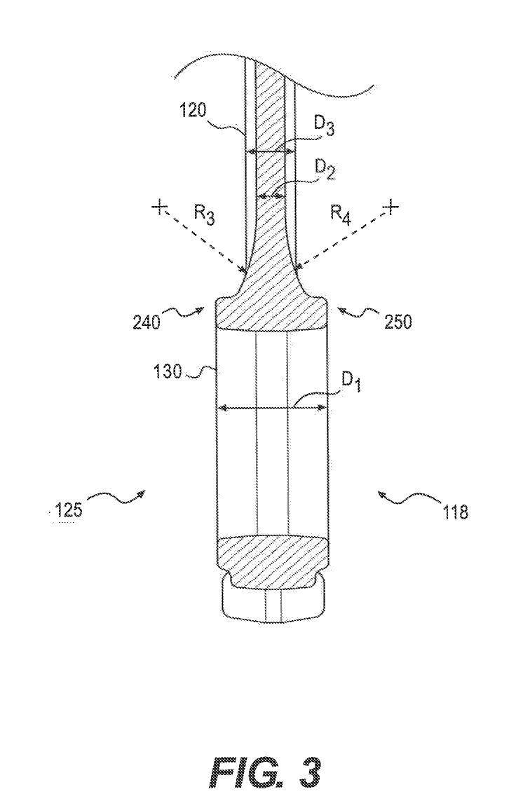

FIG. 3 depicts a cross-sectional view of connecting rod 118 taken along line A-A shown in FIG. 2. Specifically, FIG. 3 shows a portion of shank 120 and crank end 125. In the disclosed embodiment, crank end 125 may have a first face 240 and a second face 250 located at an opposing side relative to first face 240. First face 240 may be substantially symmetrical to second face 250. First face 240 may have a transitional radius of curvature R₃ at shank 120, and second face 250 may have a similar transitional radius of curvature R₄ at the same location. In one embodiment, R₃ and R₄ may both be about 80 mm. In this embodiment, a ratio of R₃ to R₄ may be about 1:1.

Also shown in FIG. 3, crank end 125 and shank 120 may have substantially different depths from first face 240 to second face 250. Crank end 125 may generally have one depth D₁. In one embodiment, D₁ may be about 50 mm. Shank 120 may have an inner depth D₂ and an outer depth D₃. In one embodiment, D₂ may be about 15 mm and D₃ may be about 30 mm. This variation in depth of shank 120 may reduce an overall mass of connecting rod 118 without sacrificing structural integrity. This reduced mass may consequently reduce the power required by engine 102 to move connecting rod 118. It should be noted that additional areas of connecting rod 118 may have different depths in order to reduce the overall mass of connecting rod 118. In the disclosed embodiment, a ratio of the inner depth of shank 120 to the outer depth shank 120 may be about 1:2. Also, in this embodiment, a ratio of the depth of crank end 125 to the outer depth of shank 120 may be about 5:3.

In the present disclosure, all parts of connecting rod 118 may be made of substantially the same material. For example, connecting rod 118 may be manufactured with any steel alloy using a process known as steel forging. It is contemplated, however, that connecting rod 118 may be made of any other material known to the art, such as aluminum, titanium, or cast iron. Strength properties of connecting rod 118 may vary depending on the material used and/or the requirements of engine 102.

### INDUSTRIAL APPLICABILITY

The disclosed connecting rod may be applicable to any engine having a connecting rod where bore distortion and/or poor bearing performance is an issue. The disclosed asymmetric outer profile of connecting rod 118 may help reduce crank end bore distortion, which often leads to poor bearing performance. In particular, the disclosed outer profile may include an increased thickness at shoulder 133 of yoke 130, where stress may be heavily concentrated during operation of engine 102. By increasing the thickness at this particular location, stress may be reduced to prevent crank end bore distortion and ensure proper bearing lubrication. The specific transitional profile that is disclosed may also allow for a solution to these problems without significantly increasing the mass of connecting rod 118.

It will be apparent to those skilled in the art that various modifications and variations can be made to the disclosed connecting rod without departing from the scope of the disclosure. Other embodiments of the connecting rod will be apparent to those skilled in the art from consideration of the specification and practice of the connecting rod disclosed herein. It is intended that the specification and examples be considered as exemplary only, with a true scope of the disclosure being indicated by the following claims and their equivalents.

What is claimed is:

1. A connecting rod, comprising:
a first end including a bore configured to receive a piston pin;
a second end including:
a yoke having a shoulder; and
a cap removably connected to the yoke at a separation plane, wherein the yoke and the cap together define a bore configured to receive a crankshaft; and
a shank extending between the first and second ends and being generally symmetrical about a longitudinal plane, the longitudinal plane being oriented at an oblique angle with respect to the separation plane,
wherein a radial thickness of the shoulder is greater than a radial thickness of the yoke at the separation plane.

2. The connecting rod of claim 1, wherein a ratio of the radial thickness of he shoulder to the radial thickness of the yoke is about 6:5.

3. The connecting rod of claim 2, wherein:
the radial thickness of the shoulder is about 30 mm; and
the radial thickness of the yoke is about 25 mm.

4. The connecting rod of claim 2, wherein the shoulder is located between an angle of about 55° with respect to the longitudinal plane and an angle of about 70° with respect to the separation plane.

5. The connecting rod of claim 4, wherein a ratio of he radial thickness of the shoulder to a radial thickness of the cap is about 15:14.

6. The connecting rod of claim 1, further including:
a concave side having a first transitional radius of curvature where the shank transitions into the second end; and
a convex side located opposite the concave side and having a second transitional radius of curvature where the shank transitions into the second end,
wherein a ratio of the first transitional radius of curvature to the second transitional radius of curvature is about 5:4.

7. The connecting rod of claim 6, wherein:
the first transitional radius of curvature is about 150 mm; and
the second transitional radius of curvature is about 120 mm.

8. The connecting rod of claim 1, further including:
a first face having a first transitional radius of curvature where the shank transitions into the second end; and
a second face located opposite the first face and having a second transitional radius of curvature where the shank transitions into the second end,
wherein a ratio of the first transitional radius of curvature to the second transitional radius of curvature is about 1:1.

9. The connecting rod of claim 8, wherein the first and second transitional radius of curvatures arc each about 80 mm.

10. The connecting rod of claim 8, wherein:
the second end includes a first depth from the first face to the second face; and
the shank includes a second depth from the first face to the second face,
wherein a ratio of the first depth to the second depth is about 5:3.

11. The connecting rod of claim 10, wherein:
the second depth includes an inner depth and an outer depth; and
a ratio of the inner depth to the outer depth is about 1:2.

12. The connecting rod of claim 1, wherein the oblique angle is about 40°-60°.

13. The connecting rod of claim 12, wherein the oblique angle is about 55°.

14. A connecting rod, comprising:
a first end including a bore configured to receive a piston pin;
a second end including:
a yoke having a shoulder;
a cap removably connected to the yoke at a separation plane, wherein the yoke and the cap define a bore configured to receive a crankshaft;
a shank extending between the first and second ends and being positioned on a longitudinal plane extending between a center axis of the bore in the first end and a center axis of the bore in the second end, the longitudinal plane being oriented at an oblique angle with respect to the separation plane;
a concave side having a first transitional radius of curvature where the shank transitions into the second end; and
a convex side located opposite the concave side and having a second transitional radius of curvature where the shank transitions into the second end,
wherein a ratio of the first transitional radius of curvature to the second transitional radius of curvature is about 5:4.

15. The connecting rod of claim 14, wherein:
the first transitional radius of curvature is about 150 mm; and
the second transitional radius of curvature is about 120 mm.

16. The connecting rod of claim 14, wherein a ratio of a radial thickness of the shoulder to a radial thickness of the yoke at the separation plane is about 6:5, the shoulder being located between an angle of about 55° with respect to the longitudinal plane and an angle of about 70° with respect to the separation plane.

17. The connecting rod of claim 16, wherein:
the radial thickness of the shoulder is about 30 mm; and
the radial thickness of the yoke is about 25 mm.

18. The connecting rod of claim 16, wherein a ratio of the radial thickness of the shoulder to a radial thickness of the cap is about 15:14.

19. The connecting rod of claim 14, wherein the oblique angle is about 55°.

20. An engine, comprising:
an engine block at least partially defining a cylinder;
a piston located to reciprocate within the cylinder;
a connecting rod connected to the piston by a piston pin, wherein the connecting rod includes:
a first end including a bore configured to receive the piston pin;
a second end including:
a yoke having a shoulder; and
a cap removably connected to the yoke at a separation plane, wherein the yoke and the cap together define a bore configured to receive a crankshaft; and
a shank extending between the first and second ends and being generally symmetrical about a longitudinal plane, the longitudinal plane being oriented at an oblique angle with respect to the separation plane,
wherein a radial thickness of the shoulder is greater than a radial thickness of the yoke at the separation plane.
